(19) United States
(12) Patent Application Publication
(10) Pub. No.: US 2024/0232579 A1
(43) Pub. Date: Jul. 11, 2024

(54) METHOD AND DEVICE WITH EXPANDING KNOWLEDGE GRAPH

(71) Applicant: SAMSUNG ELECTRONICS CO., LTD., Suwon-si (KR)

(72) Inventors: GyuBum HAN, Suwon-si (KR); Jehun JEON, Suwon-si (KR); Jangsu LEE, Suwon-si (KR); Jiseung JEONG, Suwon-si (KR); Inkyu CHOI, Suwon-si (KR)

(73) Assignee: SAMSUNG ELECTRONICS CO., LTD., Suwon-si (KR)

(21) Appl. No.: 18/524,053

(22) Filed: Nov. 30, 2023

(30) Foreign Application Priority Data
Jan. 10, 2023 (KR) 10-2023-0003740

(51) Int. Cl. G06N 3/045; G06N 3/048

(52) U.S. Cl. CPC G06N 3/045; G06N 3/048

(57) ABSTRACT

A method of expanding a knowledge graph and an electronic device for performing the method are provided. The electronic device includes a processor and the processor is configured to train a first neural network to extract the triplet using the training data, to compare quality of the trained first neural network to a threshold value using the validation data, to extract a new triplet by inputting the text data to the trained first neural network, to measure a first confidence of the new triplet using the trained first neural network, to measure a second confidence of the new triplet using a trained second neural network using a triplet labeled to the training data and a triplet labeled to the validation data, and to expand the knowledge graph based on the first confidence and the second confidence.

### CROSS-REFERENCE TO RELATED APPLICATIONS

This application claims the benefit under 35 USC § 119(a) of Korean Patent Application No. 10-2023-0003740, filed on Jan. 10, 2023, in the Korean Intellectual Property Office, the entire disclosure of which is incorporated herein by reference for all purposes.

### BACKGROUND

### 1. Field

The following description relates to a method and device with an expanding knowledge graph.

### 2. Description of Related Art

A knowledge graph (KG) is a graph that illustrates a relation between entities and includes an entity (or a node) and an edge (or a relation).

Knowledge graphs may be used in various natural language processing (NLP) tasks. A knowledge graph may be represented as a list of triplets that may have connectivity with each other. Extracting triplets from an unstructured texts can be beneficial for expanding knowledge graphs.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electronic device includes: one or more processors; and a memory electrically connected with the one or more processors and storing instructions configured to cause the one or more processors to: generate, based on a knowledge graph and original text data: training data including a first labeled triplet related to an entity and a relation of a text, validation data including a second labeled triplet related to an entity and a relation of a text, and unlabeled text data; train, with the training data, a first neural network to extract triplets; extract a new triplet by inputting the text data to the trained first neural network; measure a first confidence of the new triplet using the trained first neural network; measure a second confidence of the new triplet using a second neural network that has been trained using a first labeled triplet of the training data and the second labeled triplet of the validation data; and expand the knowledge graph based on the first confidence and the second confidence.

The instructions may be further configured to cause the one or more processors to generate the training data and the validation data so that the first labeled triplet may be different from the second labeled triplet.

The instructions may be further configured to cause the one or more processors to: compare a precision of the first neural network to a first threshold value; and compare a recall of the first neural network to a second threshold value.

The second neural network may be trained to output whether the new triplet is valid.

The instructions may be further configured to cause the one or more processors to apply a first weight of the first confidence and a second weight of the second confidence.

The first weight and the second weight may be determined based on a quality of the knowledge graph when the knowledge graph is expanded based on the first confidence and when the knowledge graph is expanded based on the second confidence.

In another general aspect, a method of expanding a knowledge graph includes:
generating, based on the knowledge graph and original text data: training data including a first triplet related to an entity and a relation of a text, validation data including a second labeled triplet related to an entity and a relation of a text, and unlabeled text data; training, with the training data, a first neural network to extract triplets; extracting a new triplet by inputting the text data to the trained first neural network; measuring a first confidence of the new triplet using the trained first neural network; measuring a second confidence of the new triplet using a second neural network that has been trained using the first labeled triplet of the training data and the second triplet labeled of the validation data; and expanding the knowledge graph based on the first confidence and the second confidence.

The generating of the training data, the validation data, and the unlabeled data may include generating the training data and the validation data so that the triplet labeled to the training data is different from the triplet labeled to the validation data.

Expanding the knowledge graph may include adding the new triplet to the knowledge graph.

The method may further include: comparing a precision of the first neural network to a first threshold value; and comparing a recall of the first neural network to a second threshold value.

The second neural network may be trained to output whether the new triplet is valid.

The expanding of the knowledge graph may include applying a first weight of the first confidence and a second weight of the second confidence.

The first weight and the second weight may be determined based on a quality of the knowledge graph when the knowledge graph is expanded based on the first confidence and when the knowledge graph is expanded based on the second confidence.

In another general aspect, a method of expanding a knowledge graph includes:
training a first neural network, using training data including a first labeled triplet related to an entity and related to a relation of a text from original text data based on a knowledge graph, to extract triplets; comparing quality of the trained first neural network to a threshold value using validation data including a second labeled triplet from the original text data; extracting a new triplet by inputting text data generated from the original text data to the trained first neural network; calculating a first confidence of the new triplet using the trained first neural network; calculating a second confidence of the new triplet using a second neural network trained using the first labeled triplet of the training data and the second labeled triplet of the validation data; calculating an accuracy of a link prediction model when the knowledge graph is expanded based on the first confidence and the second confidence; and expanding the knowledge graph with the new triplet based on the accuracy of the link prediction model.

The second neural network may be trained to output whether the new triplet is valid.

The expanding of the knowledge graph may include applying a first weight of the first confidence and a second weight of the second confidence.

The first weight and the second weight may be determined based on quality of the knowledge graph when the knowledge graph is expanded based on the first confidence and when the knowledge graph is expanded based on the second confidence.

Other features and aspects will be apparent from the following detailed description, the drawings, and the claims.

### BRIEF DESCRIPTION OF THE DRAWINGS

FIG. 1 illustrates an example electronic device, according to one or more embodiments.

FIG. 2 illustrates an example of expanding a knowledge graph, according to one or more embodiments.

FIG. 3 illustrates an example method of expanding a knowledge graph, according to one or more embodiments.

FIG. 4 illustrates an example of expanding a knowledge graph using a new triplet, according to one or more embodiments.

FIG. 5 illustrates example triplets output when text data is input to a first neural network, according to one or more embodiments.

FIG. 6 illustrates example entities and relations between the entities that are input to a second neural network, according to one or more embodiments.

FIG. 7 illustrates an example of a confidence of a new triplet determined based on a first confidence and a second confidence, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

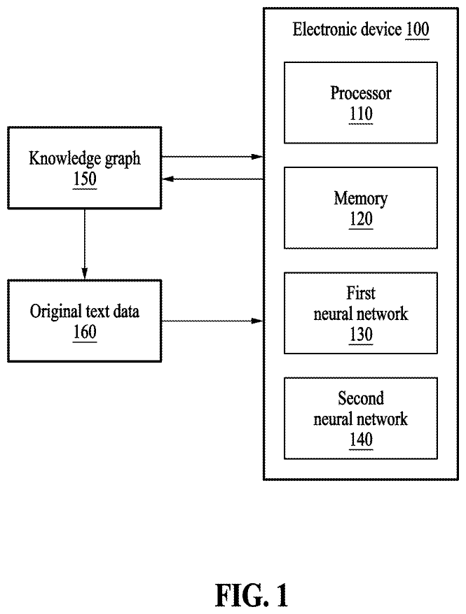

FIG. 1 illustrates an example electronic device 100, according to one or more embodiments. The electronic device 100 may include a processor 110, a memory 120, a first neural network 130, and a first neural network 140, or a combination thereof.

The processor 110, for example, may execute instructions (e.g., a program or application) to control at least one other component (e.g., a hardware or software component) of the electronic device 100 connected to the processor 110 and may perform various data processing or operations. According to an example, as at least part of data processing or operation, the processor 110 may store instructions or data received from other components (e.g., a sensor module or a communication module) in a volatile memory, process the instructions or data stored in the volatile memory, and store resulting data in a non-volatile memory. According to an example, the processor 110 may include a main processor (e.g., a central processing unit (CPU) or an application processor) and/or an auxiliary processor (e.g., a graphics processing unit (GPU), a neural processing unit (NPU)), an image signal processor, a sensor hub processor, or a communication processor, or the like) that may operate independently or together therewith. For example, when the electronic device 100 includes a main processor and an auxiliary processor, the auxiliary processor may be set to use lower power than the main processor or to be specified for a designated function. The auxiliary processor may be implemented separately from, or as part of, the main processor.

The auxiliary processor, for example, may control at least part of a function or a state of at least one component (e.g., a display module, a sensor module, or a communication module) among components of the electronic device 100 on behalf of the main processor while the main processor is in an inactive (e.g., sleep) state, or together with the main processor while the main processor is in an active (e.g., application execution) state. According to an example, the auxiliary processor (e.g., an image signal processor or a communication processor) may be implemented as part of other functionally related components (e.g., a camera module or a communication module). According to an example, the auxiliary processor (e.g., an NPU) may include a hardware structure specialized for processing an artificial intelligence (AI) model. The AI model may be generated through machine learning. Such learning may be performed, for example, in the electronic device 100 itself where the AI model is executed, or through a separate server (e.g., a server device, a cloud service, etc.). A learning algorithm may include, for example, supervised learning, unsupervised learning, semi-supervised learning, or reinforcement learning, but is not limited thereto. The AI model may include a plurality of neural network (ANN) layers. A NN may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or one of combinations of at least two of the above, but is not limited thereto. In addition to the hardware structure, the AI model may include a software structure alternatively or additionally.

The memory 120 may store a variety of data used by at least one component (e.g., the processor 110 or a sensor module) of the electronic device 100. The data may include, for example, input data or output data for software (e.g., a program) and instructions related thereto. The memory 120 may include a volatile memory or a non-volatile memory.

The electronic device 100 may generate or access training data, validation data, and text data, each derived from original text data 160, and may do so using a knowledge graph 150. The original text data 160 may be any arbitrary corpus of text, e.g., documents, which may or may not be pre-processed in various ways, e.g., with stop-words removal, lower-casing, punctuation removal, etc. The electronic device 100 may generate training data with labeled triplet and validation data with labeled triplet from the original text data 160, using entities and relations of the knowledge graph. The electronic device 100 may generate training data and verification data by correlating texts included in the original text data 160 with entities and relations of the knowledge graph.

The electronic device 100 may train the first neural network 130 using the training data generated from the original text data 160. For example, the first neural network 130 may be trained to extract a triplet by inputting the generated training data thereto. A triplet is typically a (<head>, <relation>, <tail>), or in short, [H, R, T]. The training data and the validation data may include text and triplet.

The electronic device 100 may compare quality of the first neural network 130 to a threshold value using the validation data, which has also been generated from the original text data 160.

When the quality of the first neural network 130 is greater than the preset threshold value, the electronic device 100 may extract a new triplet by inputting the text data to the first neural network 130. The new triplet may be a triplet that is not included in the training data and/or the validation data.

The electronic device 100 may calculate a first confidence of the first neural network 130 and a second confidence of the second neural network 140. The electronic device 100 may expand the knowledge graph 150 using the new triplet based on the first confidence and the second confidence.

The electronic device 100 may expand the knowledge graph 150 using the first neural network 130 and the second neural network 140. The electronic device 100 may expand the knowledge graph 150 using the new triplet extracted from the text data based on the measured first confidence and second confidence, to prevent or mitigate degradation of quality of the expanded knowledge graph 150 and reduce an effect of noise.

The electronic device 100 may determine a confidence of the new triplet using a combination of a logit value (e.g., a local confidence, which is the first confidence) of a knowledge graph automatic extraction network (e.g., the first neural network 130) with quality that has been validated using the validation data, and a logit value (e.g., a global confidence, which is the second confidence) of a network that is obtained by fine-tuning a language model (e.g., the second neural network 140) using the triplet of the knowledge graph 150.

The electronic device 100 may perform generation and/or expansion of the knowledge graph 150. The electronic device 100 may reduce the effect of noise of a pseudo label when expanding the knowledge graph 150.

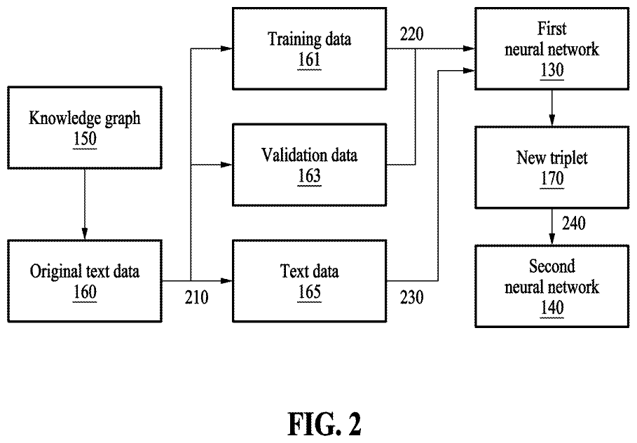

FIG. 2 illustrates an example of expanding the knowledge graph 150 of the electronic device 100, according to one or more embodiments.

In operation 210, the electronic device 100 may identify/access training data 161, validation data 163, and text data 165 generated from the original text data 160 using the knowledge graph 150. The text data 165 may include text excluding text included in the training data 161 and the validation data 163 from original text data. The text data 165 may include text that does not correspond to a triplet of the knowledge graph 150 in the original text data 160.

As noted, the electronic device 100 may generate the training data 161, the validation data 163, and the text data 165 from the original text data 160 by applying the knowledge graph 150 to the original text data 160. The electronic device 100 may generate the training data 161, the validation data 163, and the text data 165 from original text data 160 using triplets of the knowledge graph 150 using various known methods. Alternatively, the electronic device 100 may receive the training data 161, the validation data 163, and the text data 165 from another electronic device (e.g., a server, cloud service, etc.).

In operation 220, the electronic device may train the first neural network 130 using the training data 161. The first neural network 130 may be trained to extract triplets from text inputs. The text inputs may include sentences and/or paragraphs. The first neural network 130 may also be referred to as a knowledge graph extraction network, which may extract knowledge in the form of predicted/inferred triplets.

In operation 220, as part of the training of the first neural network 130, the electronic device 100 may measure a quality of the first neural network 130 using the validation data 163. For example, the electronic device 100 may calculate a precision of the first neural network and a recall of the first neural network 130 using the validation data 163 (e.g., by performing inference on the validation data and comparing a result thereof with an expected or ground truth of the validation data). The electronic device 100 may measure the performance of the first neural network 130 by inputting the validation data 163 to the first neural network 130 and comparing the output triplet from the first neural network 130 with a triplet labeled in the validation data 163. Various parameters (e.g., precision, reliability, recall) for measuring the performance of the neural network may be applied.

The electronic device 100 may compare the precision of the first neural network 130 to a first threshold value and compare the recall of the first neural network 130 to a second threshold value. When the precision of the first neural network 130 is greater than the first threshold value and the recall of the first neural network 130 is greater than the second threshold value, it may indicate that the first neural network 130 is sufficiently trained. Consequently, in operation 230, when training of the first neural network 130 is complete, the electronic device 100 may input the text data 165 to the trained first neural network 130 which extracts a new triplet 170 from the text data 165 by performing inference thereon (which may be repeated for many text data inputs).

In an example, the training data 161 and the validation data 163 may include text and a triplet derived from the original text data 160 (the training data 161 may have many texts and respective triplets). The triplets included in the training data 161 and the validation data 163 may be the labels of the respective texts included in the training data 161 and the validation data 163. The triplet may include a head entity H, a relation R, and a tail entity T and may be expressed as [H, R, T]. The knowledge graph 150 may be a graph that semantically represents relations between entities and may include entities and the relations between the entities. The knowledge graph 150 may be understood as a list of triplets having connectivity with each other (the connectivity being represented by commonalities between elements of the triplets).

The electronic device 100 and/or the external device/service may generate the training data 161 as labeled triplets and the validation data 163 as labeled triplets from the original text data 160, and may do so using a list of triplets included in the knowledge graph 150. The electronic device 100 may generate the training data 161 and the validation data 163 by matching the head entity, relation, and/or tail entity of the triplet of the knowledge graph 150 with the text of the original text data 160. Various known methods may be applied to a method of generating text data (e.g., the training data 161, the validation data 163) labeled as a triplet from the original text data 160 using the knowledge graph 150. The electronic device 100 and/or the external electronic device/service may also generate unlabeled text data 165 from the original text data 160. The training data 161 may be the data used for training the first neural network 130, and the validation data 163 may be the data used to measure performance of the first neural network 130.

In an example, a triplet labeled to the training data 161 may be different from a triplet labeled to validation data 163. In an example, the training data 161 may include a sentence A labeled as triplet A [H1, R1, T1], a sentence B labeled as triplet B [H2, R2, T2], and a sentence C labeled as triplet C [H3, R3, T3], the validation data 163 may include a sentence D labeled as triplet D [H4, R4, T4], a sentence E labeled as triplet E [H5, R5, T5], and a sentence F labeled as triplet F [H6, R6, T6]. As noted, the first neural network 130 may be trained to extract triplets from text inputs. Since the electronic device 100 may train the first neural network 130 to extract the new triplet 170 that is to be used for expanding the knowledge graph 150, the first neural network 130 may be trained to extract to a triplet that is not included in the training data 161. The electronic device 100 may measure quality of extraction of a triplet that is not included in the training data 161 when measuring the quality of the first neural network 130 using the validation data 163, and may do so by making the triplet included in the training data 161 and the triplet included in the validation data 163 different from each other.

In operation 240, the electronic device 100 may calculate the second confidence with respect to the new triplet 170 using the second neural network 140. For example, the second neural network 140 may be a language model that is fine-tuned using the training data 161 and the validation data 163. The second neural network 140 may be trained to extract a validity of a triplet using the training data 161 and the validation data 163. In an example, the second neural network 140 may output the tail entity by using the head entity and the relation of the input triplet. The second neural network 140 may measure the validity of the input triplet using the outputted tail entity and the tail entity of the input triplet. The second neural network 140 may output the validity of the input triplet using confidence measured by comparing the outputted tail entity and the tail entity of the input triplet.

For example, the second neural network 140 may be trained to receive, as input, the triplet included in the training data 161 and the triplet included in the validation data 163, and perform inference to output whether the triplet is valid. In an example, the second neural network 140 may be trained using the triplet included in the training data 161, and the performance of the second neural network may 130 be measured using the triplet included in the validation data 163. The second neural network 140 may be referred to as a triplet validation model.

For example, the language model may be a neural network model for processing natural language and may be structured as various well-known neural network models. For example, the language model may be a model that predicts a word following an input text, a model that predicts a blank word through both text contexts, or the like. For example, the language model may be a known neural network model such as a bidirectional encoder representations from transformer (BERT) model.

The electronic device 100 may calculate the second confidence of the new triplet 170 by inputting the new triplet 170 to the trained second neural network 140.

The electronic device 100 may use a known method of calculating a confidence of a neural network model to calculate the first confidence and the second confidence of the new triplet 170. For example, the first confidence may be referred to as a local confidence and the second confidence may be referred to as a global confidence.

The electronic device 100 may expand the knowledge graph 150 based on the first confidence and the second confidence. For example, the electronic device 100 may expand the knowledge graph 150 using a first weight (which is set for the first confidence) and a second weight (which is set for the second confidence).

The electronic device 100 may determine the first weight and the second weight based on the quality of the knowledge graph 150 (when the knowledge graph 150 is to be expanded) using the new triplet 170, and may do so according to the first confidence or the second confidence. For example, the electronic device 100 may expand the knowledge graph 150 according to the first confidence or the second confidence and calculate a resulting accuracy improvement value of a link prediction of the expanded knowledge graph 150. The accuracy improvement value may be calculated by substituting a natural language processing (NLP) task (e.g., question answering (QA)) related to the expanded knowledge graph 150. The electronic device 100 may determine the first weight and the second weight according to the ratio of the accuracy improvement value of the link prediction or of the related NLP task (e.g., a ratio of accuracy before expansion to accuracy after expansion).

Various known methods of measuring the quality of a knowledge graph 150 may be applied. For example, when the link prediction is applied, if TransE-based knowledge graph embedding is used, the quality of the knowledge graph 150 may include N_triplets, N_entities, N_relations, Hit@ 10, Filtered Hit@ 10, Mean Rank, Filt.MR, MRR, Filt. MRR, and the like.

A link prediction model is a model that predicts a link between two given nodes (entities) or, when a node (entity) and a link (relation) are given, predicts the corresponding other node (entity). When a link is newly added to the knowledge graph 150, the link may be validated once again through the link prediction model. In addition, it is possible to compare qualities of link prediction models when a newly expanded graph and an existing graph are used in training.

The electronic device 100 may determine the confidence of the new triplet 170 with a processor configured to perform the equivalent of Equation 1 below.

$$α \cdot confidence 1 + β \cdot confidence 2 \qquad Equation 1$$

In Equation 1, α denotes the first weight, confidence 1 denotes the first confidence, β denotes the second weight, and confidence 2 denotes the second confidence. The electronic device 100 may determine whether to add the new triplet 170 into the knowledge graph 150 based on the confidence of the new triplet 170 as calculated according to Equation 1. For example, the electronic device 100 may determine whether to add the new triplet 170 into the knowledge graph 150 by comparing the confidence of the new triplet 170 calculated according to Equation 1 to a threshold value.

For example, to determine if the knowledge graph 150 is to be expanded to include the new triplet 170, if a result of link prediction performed by the link prediction model is matched to the triplet of the expanded knowledge graph 150, the electronic device 100 determine to retain the new triplet 170 in the knowledge graph 150. In addition, if the result of link prediction performed by the link prediction model is matched to the new triplet of the expanded knowledge graph 150, the electronic device 100 may also expand the training data 161 and/or the validation data 163 based on the new triplet 170.

The electronic device 100 may filter the new triplet 170 (e.g., equal to or greater than the threshold value) based on the confidence of the new triplet 170 determined according to Equation 1. The electronic device 100 may check quality of the new triplet 170 by applying the new triplet 170 to a new NLP task or may check training quality of the NLP task by using the new triplet 170 as pseudo training data 161.

The electronic device 100 may generate the training data 161 and/or the validation data 163 from the original text data 160 using the new triplet 170 that is used in expanding the knowledge graph 150. For example, the electronic device 100 may determine a training weight of the training data 161 and/or the validation data 163 based on the first confidence and the second confidence of the new triplet 170.

For example, the electronic device 100 may expand pseudo data using the new triplet that is added into the knowledge graph 150.

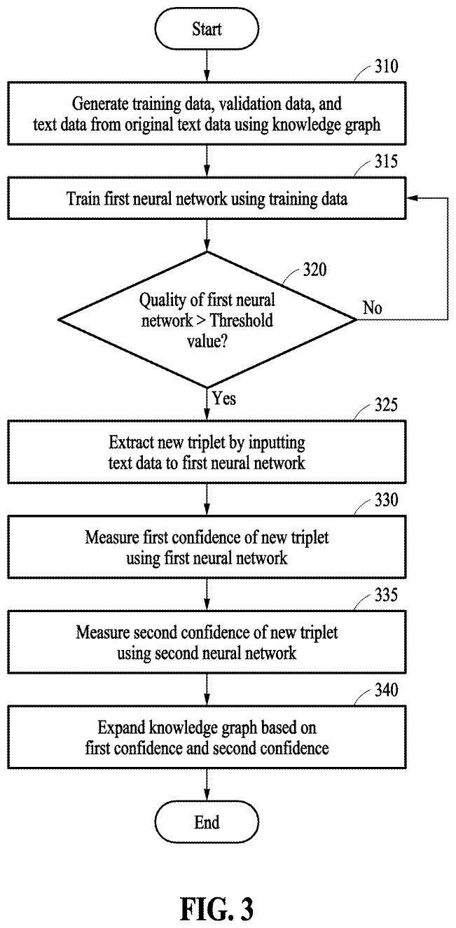

FIG. 3 illustrates a flowchart of an example method of expanding the knowledge graph 150, according to one or more embodiments.

Referring to FIG. 3, in operation 310, the electronic device 100 may generate or access the training data 161, the validation data 163, and the text data 165 from the original text data 160 using the knowledge graph 150.

The electronic device 100 may obtain a seed (initial) knowledge graph by collecting a triplet list and generating a relation list. For example, the electronic device 100 may obtain the triplet list for the seed knowledge graph by using the Korean Language Understanding Evaluation (KLUE) benchmark data as the seed knowledge graph. Alternatively, the electronic device 100 may obtain the seed knowledge graph by generating the triplet list based on an ontology.

The electronic device 100 may add an annotation to the original text data 160 using the seed knowledge graph. The electronic device 100 may compare the triplet obtained from the seed knowledge graph to a sentence of the original text data 160. When a head entity and a tail entity of the triplet are included in the original text data 160 (e.g., within a given word-distance of each other, within a same lexical unit such as a sentence, phrase, or paragraph, etc.), the electronic device 100 may label the original text data 160 as a triplet [head entity, relation, tail entity](e.g., [H, R, T]).

The electronic device 100 may sample the training data 161 and the validation data 163 using the labeled original text data 160. The electronic device 100 may sample the training data 161 and the validation data 163 such that the triplet included in the training data 161 and the triplet included in the validation data 163 are not shared.

For example, the electronic device 100 may sample the training data 161 and the validation data 163 into another sentence that shares a triplet, a sentence that shares all entities but no triplet, a sentence that shares only the head entity, a sentence that shares only the tail entity, a sentence that shares or does not share an entity and does not share a triplet, and/or a sentence that shares neither a triplet nor an entity.

For example, the electronic device 100 may classify data according to a relation and perform sampling to make a relation distribution of the training data 161 and a relation distribution of the validation data 163 be as similar as possible.

In operation 315, the electronic device 100 may train the first neural network 130 using the training data 161. More specifically, the first neural network 130 may be trained to extract the triplet of the training data 161.

Various structures and types of a neural network model may be used to implement the first neural network 130. For example, the first neural network 130 may include a network having a transformer-based structure which may extract multiple triplets.

In operation 320, the electronic device 100 may compare the quality of the first neural network 130 to a threshold value. The electronic device 100 may measure the quality of the neural network using the validation data 163. The electronic device 100 may check an inference result using the validation data 163 at each training epoch and validate a degree of training of the first neural network 130.

For example, the electronic device 100 may compare the precision and recall of the first neural network 130 to the threshold value.

In operation 320, when the quality of the first neural network 130 is greater than the threshold value, the electronic device 100 may be finished training and may be used to extract the new triplet 170 by inputting the text data 165 to the first neural network 130 in operation 325.

The electronic device 100 may filter the new triplet 170. For example, the electronic device 100 may perform filtering according to a length limit of entities of the new triplet 170, filtering according to a special character limit, pos tagging result-based filtering, entity logit threshold-based filtering, relation logit threshold-based filtering, and/or the like.

In operation 330, the electronic device 100 may measure the first confidence of the new triplet 170 using the first neural network 130. In operation 335, the electronic device 100 may measure the second confidence of the new triplet 170 using the second neural network 140.

For example, the electronic device 100 may utilize a logit value of the first neural network 130 as the first confidence of the new triplet 170 and may utilize a logit value of the second neural network 140 as the second confidence of the new triplet 170.

The electronic device 100 may utilize an inference logit value of the first neural network 130 as the first confidence. Since the quality of the first neural network 130 is validated through the validation data 163, the electronic device 100 may determine the first confidence of the new triplet 170 using a combination of a softmax value and a relation logit for extracting the entity of the first neural network 130.

The electronic device 100 may determine the second confidence using a fine-tuned second neural network 140. The second neural network 140 may be a language model that is fine-tuned using the training data 161 and the validation data 163. The electronic device 100 may calculate the second confidence by inputting the new triplet 170 to the second neural network 140.

In operation 340, the electronic device 100 may expand (add to) the knowledge graph 150 based on the first confidence and the second confidence. For example, the electronic device 100 may expand the knowledge graph 150 through TransE-based knowledge graph 150 embedding (KG embedding). For example, the electronic device 100 may determine the confidence of the new triplet 170 as in Equation 1 above. The electronic device 100 may use the determined confidence of the new triplet 170 as at least one of an extraction condition of the new triplet 170, an expansion condition of the knowledge graph 150, or a loss weight of a pseudo training label.

The electronic device 100 may add new triplets 170 that have been validated using the link prediction model (among the new triplets 170 having a high confidence, e.g., greater than the threshold value) into the validation data 163. The electronic device 100 may determine a training weight of the new triplet 170 that is added into the validation data 163.

The electronic device 100 may determine whether a new triplet 170 is to be added into the knowledge graph 150 based on the first confidence and the second confidence of the new triplet 170. The electronic device 100 may add the new triplet 170 into the knowledge graph 150 and apply the new triplet 170 to the new NLP task or use the new triplet 170 as the pseudo training data 161, to increase training efficiency of the first neural network 130 and/or other language models.

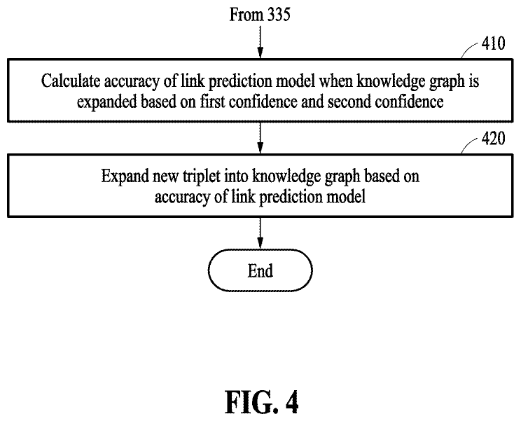

FIG. 4 illustrates an example of expanding the knowledge graph 150 using the new triplet 170, according to one or more embodiments.

Following operation 335 of FIG. 3, the electronic device 100 may perform operations illustrated in FIG. 4.

In operation 410, the electronic device 100 may calculate an accuracy of the link prediction model based on the first confidence and the second confidence when the knowledge graph 150 is expanded. For example, the electronic device 100 may expand the knowledge graph 150 according to the first confidence by adding the new triplet 170 and may then calculate the accuracy of the link prediction model. In addition, the electronic device 100 may expand the knowledge graph 150 according to the second confidence using the new triplet 170 and may calculate the accuracy of the link prediction model.

In operation 420, the electronic device 100 may add the new triplet 170 to the knowledge graph 150 based on the accuracy of the link prediction model (i.e., determine to retain the new triplet 170 in the knowledge graph 150).

For example, the electronic device 100 may determine the weights a and B in Equation 1 above using a ratio of a variation of the accuracy of the link prediction model when the knowledge graph 150 is expanded using the new triplet 170 (according to the first confidence) and a variation of the accuracy of the link prediction model when the knowledge graph 150 is expanded using the new triplet 170 (according to the second confidence), i.e., variations between the unexpanded knowledge graph 150 and the expanded knowledge graph 150. The confidence of the new triplet 170 may then be determined using the weights a and B. Whether to expand the knowledge graph 150 using the new triplet 170 may be determined based on the confidence of the new triplet 170.

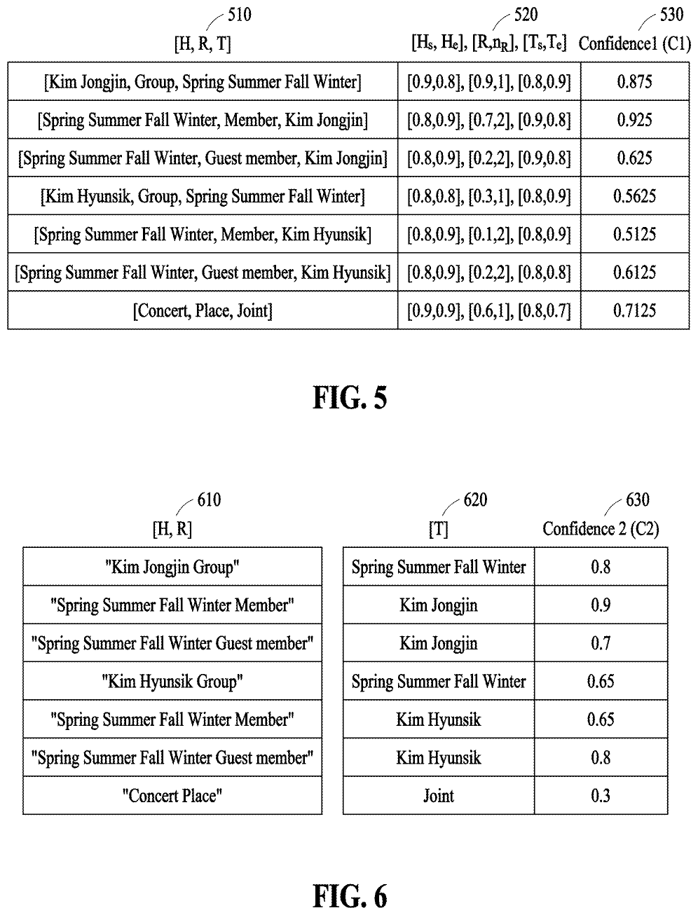

FIG. 5 illustrates example triplets output when the text data 165 is input to the first neural network 130, according to one or more embodiments. FIG. 5 illustrates triplets output when the text data 165 “Spring Summer Fall Winter, which includes Kim Jongjin, and Kim Hyunsik held a joint concert.” is input to the first neural network 130.

The electronic device 100 may output a new triplet 510 using the input text data 165 as in FIG. 5. The new triplet 510 may be represented as [H, R, T]. For example, the new triplet 510 [Kim Jongjin, Group, Spring Summer Fall Winter] may represent a triplet where the head entity H is “Kim Jongjin,” the relation R is “Group,” and the tail entity T is “Spring Summer Fall Winter.”

The electronic device 100 may determine a first confidence 530 using a logit 520 of the first neural network 130 (i.e., an unnormalized/raw prediction of the new triplet 510 outputted by the first neural network 130). For example, in the logit 520 of FIG. 5, Hₛ represents a head entity start logit, Hₑ represents a head entity end logit, R represents a relation extraction logit, n_{R} represents a number of relations for a given entity pair, Tₛ represents a tail entity start logit, and Tₑ represents a tail entity end logit.

For example, for the new triplet 510 [Kim Jongjin, Group, Spring Summer Fall Winter], the electronic device 100 may determine the logit 520 to be [0.9,0.8], [0.9,1], and [0.8,0.9] and the first confidence 530 (e.g., Confidence 1 or C1 of FIG. 5) to be 0.875. For example, the electronic device 100 may determine the first confidence using a function ƒ (Hₛ, Hₑ, R, n_{R}, Tₛ, Tₑ). The first confidence may correspond to local confidence.

FIG. 6 illustrates example entities and relations between the entities that are input to the second neural network 140 and entities that are output, according to one or more embodiments.

For example, the second neural network 140 may be previously trained to able to receive the new triplet 510 as input and to determine the validity of the new triplet 510.

The electronic device 100 may input data 610 to the second neural network 140 using the new triplet 510 of FIG. 5. The data 610 may be represented as [H, R], e.g., a truncation of the new triplet 510. For example, the data 610 “Kim Jongjin, Group” may represent data where the head entity H is “Kim Jongjin” and the relation R is “Group.” from the new triplet 510. In some embodiments, a Head may be truncated, a Tail retained, and [R, T] may be the input data 610.

The second neural network 140 may output a predicted tail entity 620 of the data 610 inferred from the input data 610. The electronic device 100 may calculate a second confidence 630 (e.g., Confidence 2 or C2 of FIG. 6) using the tail entity 620 that is output from the second neural network 140. For example, the second confidence may be determined by comparing a tail entity of a triplet corresponding to data 610 with a tail entity output from the second neural network 140. The second neural network 140 and/or the electronic device 100 may calculate the second confidence using a tail entity of a triplet corresponding to data 610 with a tail entity output from the second neural network 140.

For example, in FIG. 6, the electronic device 100 may output the tail entity 620 “Spring Summer Fall Winter” by inputting the data 610 “Kim Jongjin, Group” to the second neural network 140 and may determine the second confidence of the new triplet [Kim Jongjin, Group, Spring Summer Fall Winter] to be 0.8. The second confidence may correspond to global confidence and may be proportional to (or based on) a probability (or logit) outputted by the second neural network 140 for the part of the new triplet (e.g., tail entity 620) predicted by the second neural network 140 from the input 610.

The second neural network 140 illustrated in FIG. 6 may represent a language model that is trained to input the head entity and the relation a triplet (e.g., the new triplet) and to predict the corresponding tail entity and consequently to determine whether the triplet (e.g., the new triplet) is valid, but is not limited thereto. For example, various language models to validate the validity of the new triplet, such as a language model trained to receive as input the head entity and the tail entity of the new triplet and to predict the corresponding relation, may be applied to the second neural network 140.

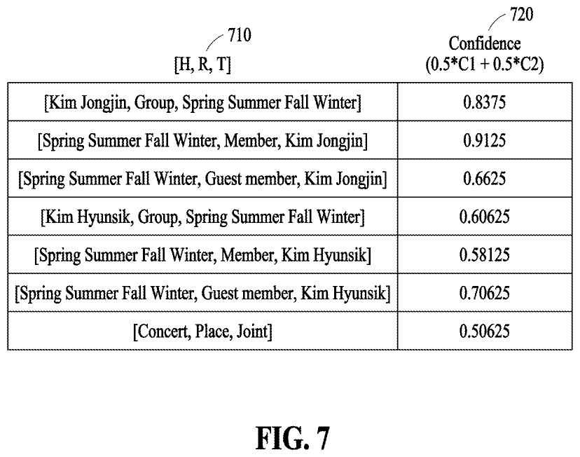

FIG. 7 illustrates an example of confidence of a new triplet determined based on a first confidence and a second confidence, according to one or more embodiments.

The electronic device 100 may determine a confidence 720 (e.g., Confidence of FIG. 7) of a new triplet 710 based on the first confidence 530 and the second confidence 630 calculated as in FIGS. 5 and 6.

For example, the confidence 720 of the new triplet 710 of FIG. 7 be a weighted combination of the first and second confidences, where the first weight a and the second weight β in Equation 1 above are each 0.5 (the first weight a and the second weight ß may have other values).

A threshold value of a confidence to determine whether to expand the knowledge graph 150 by adding the new triplet 710 may be 0.7. In the example of FIG. 7, the top two triplets would be added and the bottom five triplets would not be added.

For example, the electronic device 100 may determine the confidence 720 of the new triplet 710 [Kim Jongjin, Group, Spring Summer Fall Winter] to be 0.8375. Since the determined confidence 720 is greater than the threshold value, 0.7, the electronic device 100 may expand the knowledge graph 150 using the new triplet 710 [Kim Jongjin, Group, Spring Summer Fall Winter].

For example, the electronic device 100 may determine the confidence 720 of the new triplet 710 [Spring Summer Fall Winter, Guest member, Kim Jongjin] to be 0.6625. Since the determined confidence 720 is less than 0.7, the electronic device 100 may not expand the knowledge graph 150 using the new triplet 710 [Spring Summer Fall Winter, Guest member, Kim Jongjin].

The computing apparatuses, the electronic devices, the processors, the memories, the displays, the neural networks, the information output system and hardware, the storage devices, and other apparatuses, devices, units, modules, and components described herein with respect to FIGS. 1-7 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An electronic device comprising:
one or more processors; and
a memory electrically connected with the one or more processors and storing instructions configured to cause the one or more processors to:
generate, based on a knowledge graph and original text data: training data comprising a first labeled triplet related to an entity and a relation of a text, validation data comprising a second labeled triplet related to an entity and a relation of a text, and unlabeled text data;
train, with the training data, a first neural network to extract triplets;
extract a new triplet by inputting the text data to the trained first neural network;
measure a first confidence of the new triplet using the trained first neural network;
measure a second confidence of the new triplet using a second neural network that has been trained using a first labeled triplet of the training data and the second labeled triplet of the validation data; and
expand the knowledge graph based on the first confidence and the second confidence.

2. The electronic device of claim 1, wherein the instructions are further configured to cause the one or more processors to generate the training data and the validation data so that the first labeled triplet is different from the second labeled triplet.

3. The electronic device of claim 1, wherein the instructions are further configured to cause the one or more processors to:
compare a precision of the first neural network to a first threshold value; and
compare a recall of the first neural network to a second threshold value.

4. The electronic device of claim 1, wherein the second neural network is trained to output whether the new triplet is valid.

5. The electronic device of claim 1, wherein the instructions are further configured to cause the one or more processors to apply a first weight of the first confidence and a second weight of the second confidence.

6. The electronic device of claim 5, wherein the first weight and the second weight are determined based on a quality of the knowledge graph when the knowledge graph is expanded based on the first confidence and when the knowledge graph is expanded based on the second confidence.

7. A method of expanding a knowledge graph, the method comprising:
generating, based on the knowledge graph and original text data: training data comprising a first triplet related to an entity and a relation of a text, validation data comprising a second labeled triplet related to an entity and a relation of a text, and unlabeled text data;
training, with the training data, a first neural network to extract triplets;
extracting a new triplet by inputting the text data to the trained first neural network;
measuring a first confidence of the new triplet using the trained first neural network;
measuring a second confidence of the new triplet using a second neural network that has been trained using the first labeled triplet of the training data and the second triplet labeled of the validation data; and
expanding the knowledge graph based on the first confidence and the second confidence.

8. The method of claim 7, wherein the generating of the training data, the validation data, and the unlabeled data comprises:
generating the training data and the validation data so that the triplet labeled to the training data is different than the triplet labeled to the validation data.

9. The method of claim 7, wherein expanding the knowledge graph comprises adding the new triplet to the knowledge graph.

10. The method of claim 7, further comprising:
comparing a precision of the first neural network to a first threshold value; and
comparing a recall of the first neural network to a second threshold value.

11. The method of claim 7, wherein the second neural network is trained to output whether the new triplet is valid.

12. The method of claim 7, wherein the expanding of the knowledge graph comprises applying a first weight of the first confidence and a second weight of the second confidence.

13. The method of claim 11, wherein the first weight and the second weight are determined based on a quality of the knowledge graph when the knowledge graph is expanded based on the first confidence and when the knowledge graph is expanded based on the second confidence.

14. A method of expanding a knowledge graph, the method comprising:
training a first neural network, using training data comprising a first labeled triplet related to an entity and related to a relation of a text from original text data based on a knowledge graph, to extract triplets;
comparing quality of the trained first neural network to a threshold value using validation data comprising a second labeled triplet from the original text data;
extracting a new triplet by inputting text data generated from the original text data to the trained first neural network;
calculating a first confidence of the new triplet using the trained first neural network;
calculating a second confidence of the new triplet using a second neural network trained using the first labeled triplet of the training data and the second labeled triplet of the validation data;
calculating an accuracy of a link prediction model when the knowledge graph is expanded based on the first confidence and the second confidence; and
expanding the knowledge graph with the new triplet based on the accuracy of the link prediction model.

15. The method of claim 14, wherein the second neural network is trained to output whether the new triplet is valid.

16. The method of claim 14, wherein the expanding of the knowledge graph comprises applying a first weight of the first confidence and a second weight of the second confidence.

17. The method of claim 16, wherein the first weight and the second weight are determined based on quality of the knowledge graph when the knowledge graph is expanded based on the first confidence and when the knowledge graph is expanded based on the second confidence.
